(19) United States
(12) Patent Application Publication
(10) Pub. No.: US 2012/0140284 A1
(43) Pub. Date: Jun. 7, 2012

(54) IMAGE FORMING APPARATUS, METHOD OF CONTROLLING THE SAME AND IMAGE DISPLAY APPARATUS

(75) Inventors: Hirohiko Tashiro, Kawasaki-shi (JP); Hiroshi Tanioka, Yokohama-shi (JP); Yoshitaka Oba, Kawasaki-shi (JP); Kouichi Unno, Yokohama-shi (JP); Daiji Kirihata, Kawasaki-shi (JP); Akio Ito, Yokohama-shi (JP); Kenji Hara, Kawasaki-shi (JP)

(73) Assignee: CANON KABUSHIKI KAISHA, Tokyo (JP)

(21) Appl. No.: 13/375,116

(22) PCT Filed: Oct. 7, 2011
(86) PCT No.: PCT/JP2011/073754

§ 371 Date: Nov. 29, 2011

(30) Foreign Application Priority Data
Nov. 1, 2010 (JP) 2010-245705

(51) Int. Cl. G06K 15/02

(52) U.S. Cl. 358/1.15

(57) ABSTRACT

An image forming apparatus removably having an operation panel having a display unit, an imaging unit and a wireless communication unit communicable with the image forming apparatus. In a status where the operation panel is not mounted on the image forming apparatus, an image indicating an operation method is combined with a video image obtained by the imaging unit and displayed on the display unit, and the combined image is displayed.

### BACKGROUND OF THE INVENTION

1. Field of the Invention

The present invention relates to an image forming apparatus having an operation panel removable from an apparatus main body, a method of controlling the image forming apparatus, and an image display apparatus.

2. BACKGROUND ART

Conventionally, in an image forming apparatus such as a multi-function peripheral, an image forming apparatus main body (hereinbelow, “main body”) is provided with an operation panel having a display unit. Upon error recovery or adjustment, a procedure for such purpose or the like is displayed on the display unit. Further, in a large sized machine having a finisher and various paper discharge processing devices in its main body, the operation panel is removable from the main body. In this arrangement, upon error recovery or adjustment, a user moves with the operation panel to a position to conduct an operation, and the user can perform the operation while watching the operation procedure displayed on the display unit of the operation panel.

Further, in recent years, a so-called augmented reality technique, capable of animation-like expression of augmented actual video image, by superposing an animation previously generated with CG or the like on a video image obtained with a camera, has been proposed (Japanese Patent Laid-Open No. 2001-92995).

When the scale of the system is increased by attaching various paper discharge and post processing devices to the image forming apparatus, the number of operations depending on the operator is increased. On the other hand, the operation procedure by the user becomes complicated, and it is impossible to perform sufficient maintenance operation merely with a manual or an operation guide displayed on the operation panel for an apparatus without a specialized operator.

### SUMMARY OF INVENTION

An aspect of the present invention is to eliminate the above-mentioned problems with the conventional technology.

One of the features of the present invention is that an operation panel, removable from an apparatus main body and capable of wireless communication with the apparatus main body, is provided with an image capturing unit, and an operation guide image is combined with a video image, captured and displayed by the image capturing unit. With this arrangement, it is possible to improve operability of an operator.

According to one aspect of the present invention, there is provided an image forming apparatus for forming an image on a recording medium based on image data, comprising: mounting means for removably mounting an operation panel having a display unit, an imaging unit, and a wireless communication unit communicable with the image forming apparatus; communication means for wireless communication with the wireless communication unit of the operation panel; and control means for, in a status where the operation panel is not mounted on the mounting means, performing control to combine an image indicating an operation method with a video image obtained by the imaging unit and displayed on the display unit and display the combined image.

According to another aspect of the present invention, there is provided a control method for an image forming apparatus having a mounting unit to removably mount an operation panel having a display unit, an imaging unit, and a wireless communication unit communicable with an image forming apparatus, comprising: a communication step of performing wireless communication with the wireless communication unit of the operation panel; and a control step of, in a status where the operation panel is not mounted on the mounting unit, performing control to combine an image indicating an operation method with a video image obtained by the imaging unit and displayed on the display unit and display the combined image.

According to still another aspect of the present invention, there is provided an image display apparatus having a display unit and an imaging unit, removable from an image forming apparatus, comprising: wireless communication means for wireless communication with the image forming apparatus; display control means for, in a status where the operation panel is not mounted on the image forming apparatus, displaying a video image obtained by the imaging unit on the display unit; acquisition means for acquiring information on an error occurred in the image forming apparatus; recognition means for recognizing a part as an operation subject from the video image displayed by the display control means based on the information related to the error acquired by the acquisition means; and operation guide display means for combining an image indicating an operation guide corresponding to the part recognized by the recognition means, based on the information related to the error, with the video image, and displaying the combined image.

Further features and aspects of the present invention will become apparent from the following description of exemplary embodiment, with reference to the attached drawings.

### BRIEF DESCRIPTION OF DRAWINGS

The accompanying drawings, which are incorporated in and constitute a part of the specification, illustrate an embodiment of the invention and, together with the description, serve to explain the principles of the invention.

FIG. 1A depicts a view schematically illustrating a configuration of a system including an image forming apparatus according to an embodiment of the present invention;

FIG. 1B depicts a view illustrating an operation panel;

FIG. 2 is a block diagram showing a configuration of a main body, a home position and an operation display panel;

FIGS. 3A and 3B depict views illustrating examples of a screen image displayed on a display unit of the operation panel;

FIGS. 4A and 4B depict views illustrating examples of the screen image displayed on the display unit of the operation panel;

FIGS. 5A and 5B depict views illustrating examples of the screen image displayed on the display unit of the operation panel;

FIGS. 6A and 6B depict views illustrating examples of the screen image displayed on the display unit of the operation panel;

FIGS. 7A and 7B depict views illustrating examples of the screen image displayed on the display unit of the operation panel;

FIG. 8 depicts a view illustrating an example of a table showing an example of initial screen setting of the operation panel according to the embodiment;

FIG. 9 is a flowchart for describing initial screen display processing in the operation panel according to the embodiment;

FIG. 10 is a sequence diagram showing information transmission/reception between the operation panel and and the main body;

FIG. 11 is a flowchart for describing augmented reality processing (S27) in the embodiment;

FIGS. 12A and 12B are explanatory diagrams of an display example in the augmented reality processing (S27);

FIGS. 13A and 13B are explanatory diagrams of an display example in the augmented reality processing (S27);

FIGS. 14A and 14B are explanatory diagrams of an display example in the augmented reality processing (S27);

FIG. 15 is a flowchart for describing processing in the main body according to the embodiment; and

FIG. 16 depicts a view illustrating a particular example of an operation using the operation panel according to the embodiment.

### DESCRIPTION OF EMBODIMENTS

An embodiment of the present invention will now be described hereinafter in detail, with reference to the accompanying drawings. It is to be understood that the following embodiment is not intended to limit the claims of the present invention, and that not all of the combinations of the aspects that are described according to the following embodiment is necessarily required with respect to the means to solve the problems according to the present invention.

Further, in the present embodiment, an image forming apparatus (image processing apparatus) will be described, however, the present invention is not limited to the image forming apparatus.

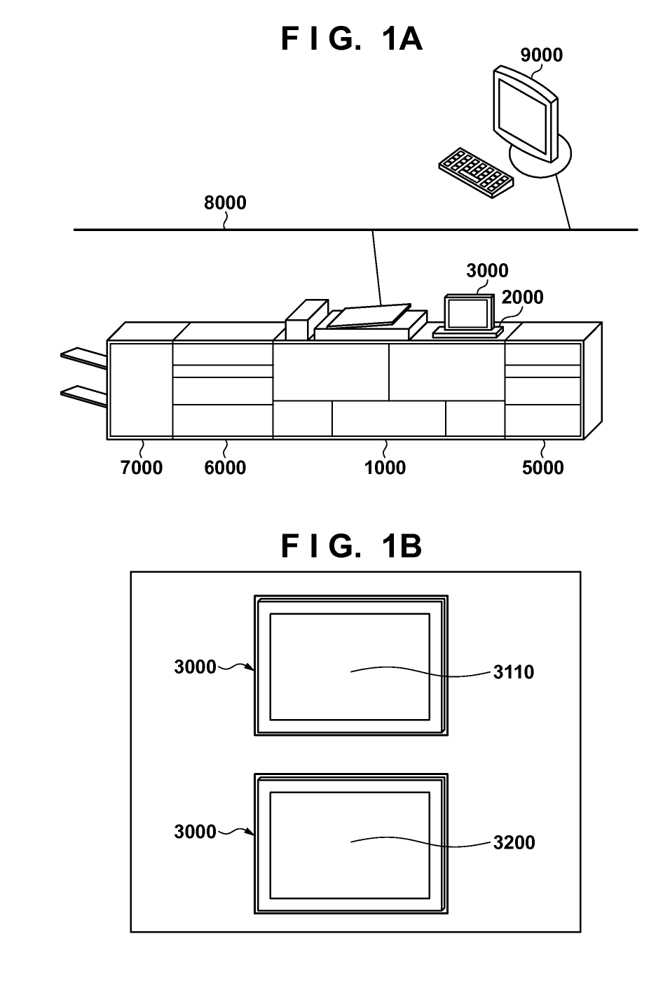

FIG. 1A depicts a view schematically illustrating a configuration of a system including an image forming apparatus 1000 according to the embodiment of the present invention.

The image forming apparatus (image processing apparatus) 1000 is a so-called print-on-demand (POD) machine which responds to various types of printing and bookbinding requirements by combining various options for saddle stitching, cutting, folding process and the like. The present embodiment shows an example of a system as a combination of the image forming apparatus main body (hereinbelow, “main body”) 1000, a paper deck (feeding unit) 5000, a binder (bookbinding unit) 6000 and a finisher (cutting unit or the like) 7000.

The main body 1000 is connected to a personal computer 9000 via a LAN 8000. The personal computer 9000 generates a print job such as print page generation/editing, setting of bookbinding, cutting, folding process, or the like. The generated print job is sent to the main body 1000 via the LAN 8000.

Further, in FIG. 1A, an operation panel (image display apparatus) 3000, removable from the main body 1000, is attached to a home position 2000 on the main body 1000. This operation panel 3000, when attached to the home position 2000, is charged with electric power supplied from the main body.

FIG. 1B depicts a view illustrating the operation panel 3000. The operation panel 3000 is provided with an LCD (display unit) 3200 on its display surface, and an imaging module 3110 is packaged on the rear surface. A user can operate the operation panel 3000 while watching the display screen of the display unit 3200 by bringing the operation panel 3000 removed from the home position 2000. Further, a video image obtained with the imaging module 3110 on the rear surface can be displayed on the display unit 3200 on the front surface.

Note that the optional devices including the paper deck 5000, the binder 6000 and the finisher 7000 are not directly related to the present invention, therefore, the detailed descriptions of these devices will be omitted.

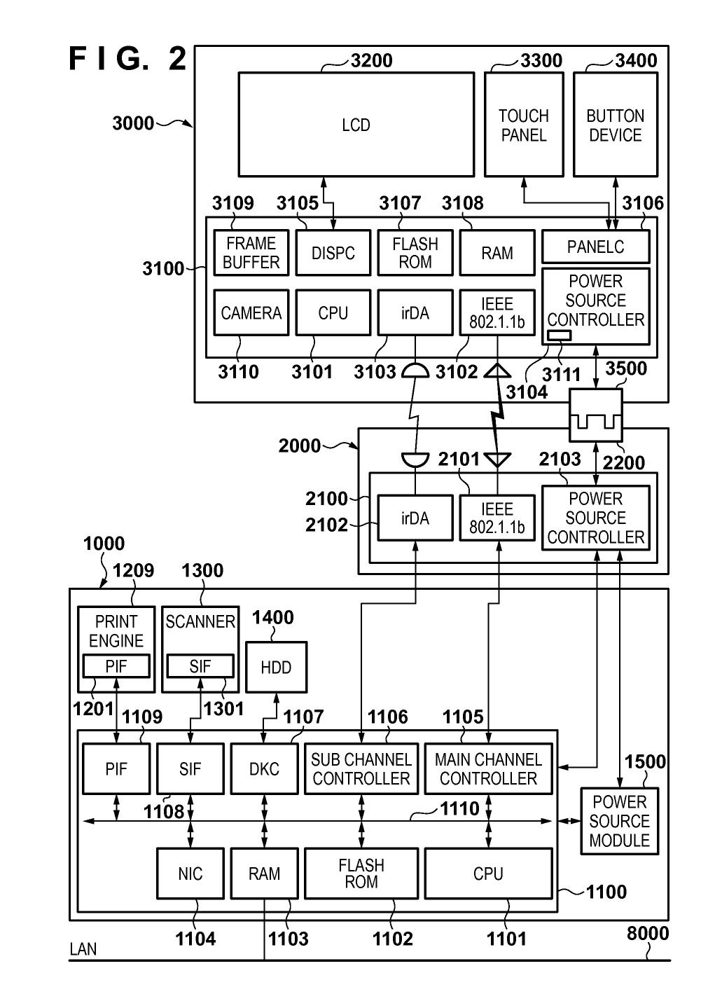

FIG. 2 is a block diagram showing a configuration of the main body 1000, the home position 2000 and the operation panel 3000. Hereinbelow, modules as the main body 1000, the home position 2000 and the operation panel 3000 will be described. First, the main body 1000 will be described.

As shown in FIG. 2, the main body 1000 has a controller board 1100, a print engine 1200, a scanner 1300, a hard disk drive (HDD) 1400 and a power source module 1500. The respective devices operate with electric power supplied from the power source module 1500.

The controller board 1100 has a CPU 1101, a flash ROM 1102, a RAM 1103, a network interface card (NIC) 1104, a main channel controller 1105, and a sub channel controller 1106. Further, the controller board 1100 has a disk controller (DKC) 1107, a scanner interface (SIF) 1108 and a printer interface(PIF) 1109. These devices 1101 to 1109 are respectively connected via a bus 1110 to the CPU 1101.

The CPU 1101 controls the respective devices connected to the bus 1110, and executes a control program stored in the flash ROM 1102 and the HDD 1400. The RAM 1103 is used as a main memory and as a work area for the CPU 1101. The NIC 1104 performs bidirectional data transmission via the LAN 8000 with the personal computer 9000 and another image forming apparatus. The HDD 1400, accessed via the DKC 1107, is used for temporary storage of image data in addition to storage of the control program.

The scanner 1300 has a reading sensor, a document feeding mechanism and the like (all not shown). The reading sensor, the document feeding mechanism and the like are controlled in accordance with a software program executed by the CPU 1101 via the SIF 1108 packaged on the controller board 1100 and an SIF 1301 packaged on the scanner 1300. As a result, the scanner 1300 reads an original with the reading sensor, and transfers the obtained data via the SIF 1301 and the SIF 1108 to the controller board 1100.

Further, the print engine 1200 has an electrophotographic type print unit, a paper cassette, a paper feeding unit and the like (all not shown). A print request based on a print job is sent from the controller board 1100 via the PIF 1109 and the PIF 1201 packaged on the print engine 1200. The print unit, the paper feeding unit and the like are controlled in accordance with a program executed by the CPU 1101 via the PIF 1109 and the PIF 1201 as in the case of the print request. As a result, the print engine 1200 forms an image corresponding to a print request on paper.

The main channel controller 1105 and the sub channel controller 1106 are used upon communication between the main body 1000 and the operation panel 3000 that is removable from the main body 1000. The details of the channel controllers will be described later.

Next, the home position 2000 will be described.

As shown in FIG. 2, the home position 2000 mainly has a main board 2100 and a connector 2200. The main board 2100 mainly has an IEEE 802.11b module 2101, an irDA module 2102 and a power source controller 2103. The IEEE 802.11b module 2101, connected to the main channel controller 1105 of the controller board 1100, serves as an interface in wireless communication with the operation panel 3000 based on a request from the controller board 1100. Further, the irDA module 2102, connected to the sub channel controller 1106 of the controller board 1100, serves as an interface in infrared communication with the operation panel 3000 based on a request from the controller board 1100. The power source controller 2103 is connected to the power source module 1500. The IEEE 802.11b module 2101 and the irDA module 2102 are supplied with electric power via the power source controller 2103. Further, when a connector 3500 of the operation panel 3000 is in a contact state, the power source controller 2103, also connected to the connector 2200, supplies electric power to the operation panel 3000. In addition, the power source controller 2103 monitors electric power supply status, detects whether or not the operation panel 3000 is attached to the home position 2000, and transmits the result of detection to the controller board 1100.

Next, the operation panel 3000 will be described.

The removable operation panel 3000 mainly has a main board 3100, the display unit (LCD) 3200, a touch panel 3300, a button device (buttons) 3400, and the connector 3500. The main board 3100 has a CPU 3101, an IEEE 802.11b module 3102, an irDA module 3103 and a power source controller 3104. Further, the main board 3100 has a display controller (DISPC) 3105, a panel controller (PANELC) 3106, a flash ROM 3107 and a RAM 3108. The respective modules 3101 to 3108 are connected with a bus (not shown) as in the case of the controller board 1100.

The CPU 3101 is a processor which controls the respective devices connected to the bus, and executes a control program stored in the flash ROM 3107. The RAM 3108 functions as a main memory and as a work area for the CPU 3101, and a storage area for video data to be displayed on the display unit 3200. The imaging module (camera) 3110 has its optical lens in the rear of the display unit 3200. When an operator holds the screen of the display unit 3200 in front of a subject, video image information in the rear surface direction of the display unit 3200 is stored into a frame buffer 3109. In the present embodiment, the video image information stored in the frame buffer 3109 is subjected to recognition processing using the CPU 3101. Then, the processed actual video image information and animation CG information previously stored in the flash ROM 3107 are superimposed in the RAM 3108, and the result is displayed on the display unit 3200.

The display controller (DISPC) 3105 transfers the video image loaded on the RAM 3108 to the display unit 3200 in correspondence with a request from the CPU 3101 and controls the display unit 3200. As a result, the image is displayed on the display unit 3200. The panel controller (PANELC) 3106 controls the touch panel 3300 and the button device 3400 in correspondence with a request from the CPU 3101. In accordance with the control, a depression position on the touch panel 3300, a key code of the depressed button on the button device 3400 and the like are returned to the CPU 3101. The power source controller 3104, connected to the connector 3500, is supplied with electric power from the power source module 1500 of the main body 1000 when it is in contact with the connector 2200 of the home position 2000. With this arrangement, electric power is supplied to the entire operation panel 3000 while a rechargeable battery 3111 connected to the power source controller 3104 is charged. When electric power is not supplied from the power source module 1500, electric power from the rechargeable battery 3111 is supplied to the entire operation panel 3000.

The IEEE 802.11b module 3102 establishes wireless communication with the IEEE 802.11b module 2101 on the home position 2000 based on the control of the CPU 3101, and serves as an interface between the operation panel 3000 and the main body 1000. The irDA module 3103 establishes infrared communication with the irDA module 2102 on the home position 2000 based on the control of the CPU 3101, and serves as an interface between the operation panel 3000 and the main body 1000.

Next, the wireless communication as a main channel according to the present embodiment will be described.

As described in FIG. 2, in the present embodiment, the wireless communication as a main channel is performed in conformance with the IEEE 802.11b standards as a known technique. More specifically, in the system of the present embodiment, the wireless communication is performed in the infrastructure mode where the main body 1000 is an access point (AP) and the operation panel 3000 is a terminal.

When plural main bodies exists within a range of a radio wave from the operation panel 3000, as in the case of an existing personal computer, the ESSIDs of plural communicable main bodies are displayed on the display unit of the operation panel 3000 so that one of the ESSIDs can be selected.

When communication with a destination has been established by association, the operation panel 3000 according to the present embodiment operates as a screen transfer type thin client. That is, most of the actual processings and video image generation are performed by the CPU 1101 of the main body 1000. Then the generated video data is sent by wireless communication in accordance with a predetermined protocol from the main body 1000 to the operation panel 3000. The CPU 3101 of the operation panel 3000 receives the video data, then controls the DISPC 3105 while loading the received video data on the RAM 3108, to display an image on the display unit 3200.

On the other hand, information related to the user's operation with respect to the touch panel 3300 and the button device 3400 of the operation panel 3000 is also sent by wireless communication in accordance with a predetermined protocol from the operation panel 3000 to the main body 1000. The information related to the operation includes a depression position on the touch panel 3300 and a key code corresponding to the depressed button of the button device 3400. The CPU 1101 of the main body 1000 receives the information related to the operation, controls the respective operations based on the sent information, updates video data in accordance with necessity, and sends the video data to the operation panel 3000 as described above.

As described above, in the system according to the present embodiment, wireless communication between the main body 1000 and the operation panel 3000 can be performed.

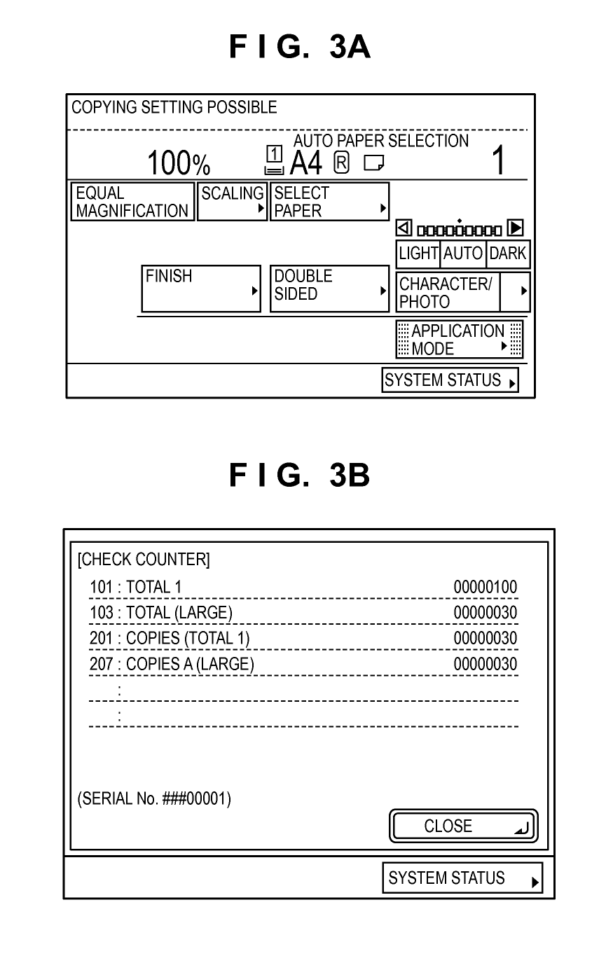

FIGS. 3A and 3B to FIGS. 7A and 7B depict views illustrating examples of the screen image displayed on the display unit 3200 of the operation panel 3000. Hereinbelow, the respective screens will be described.

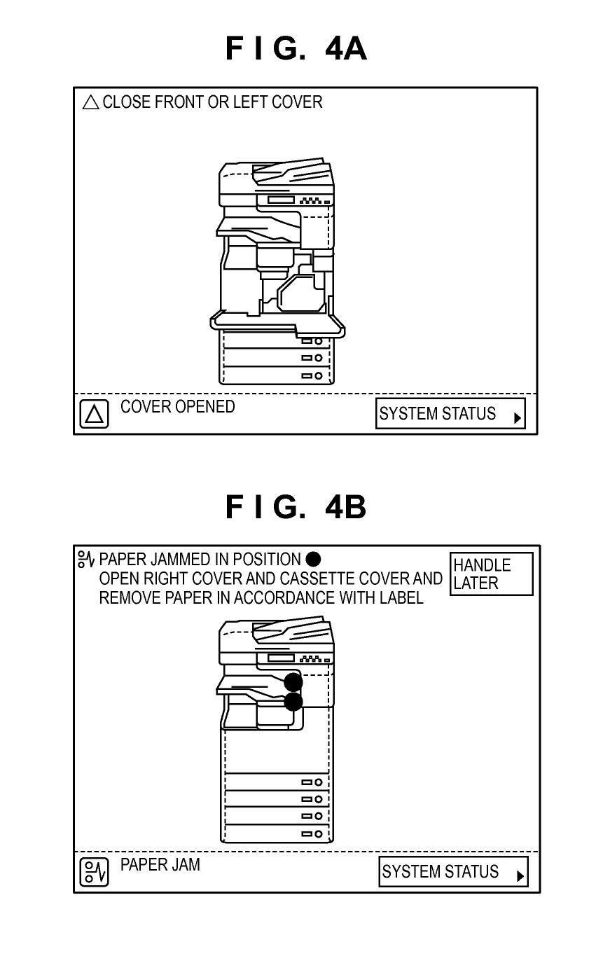

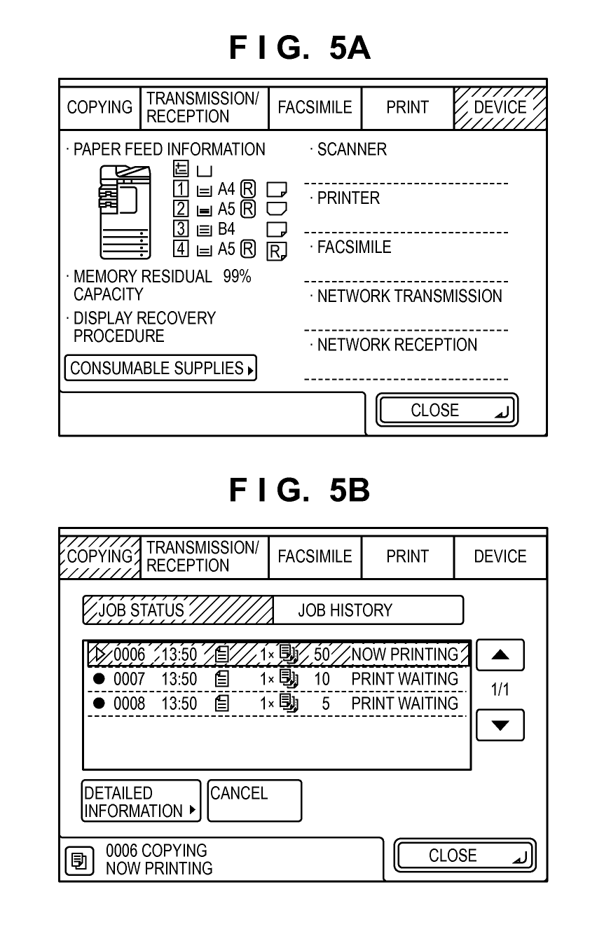

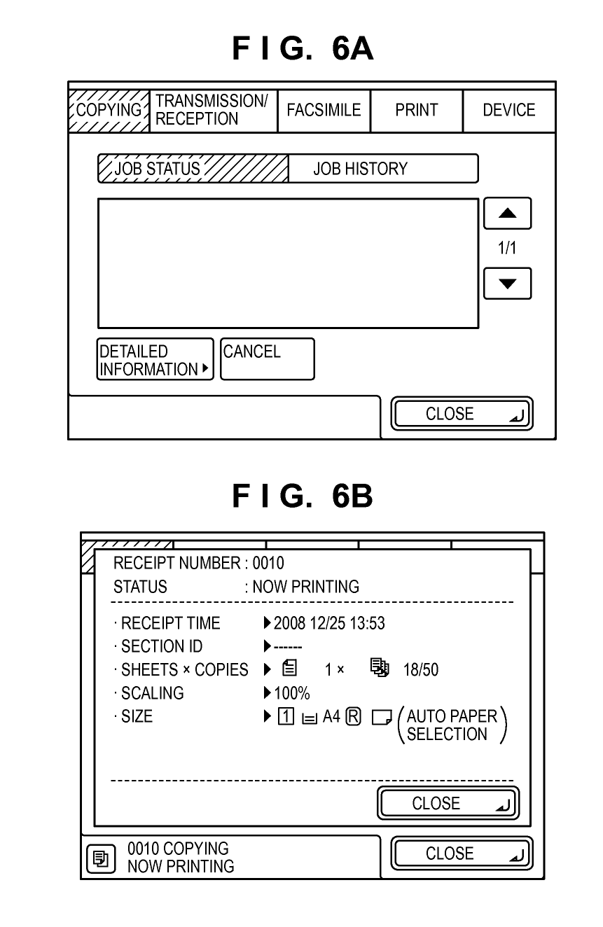

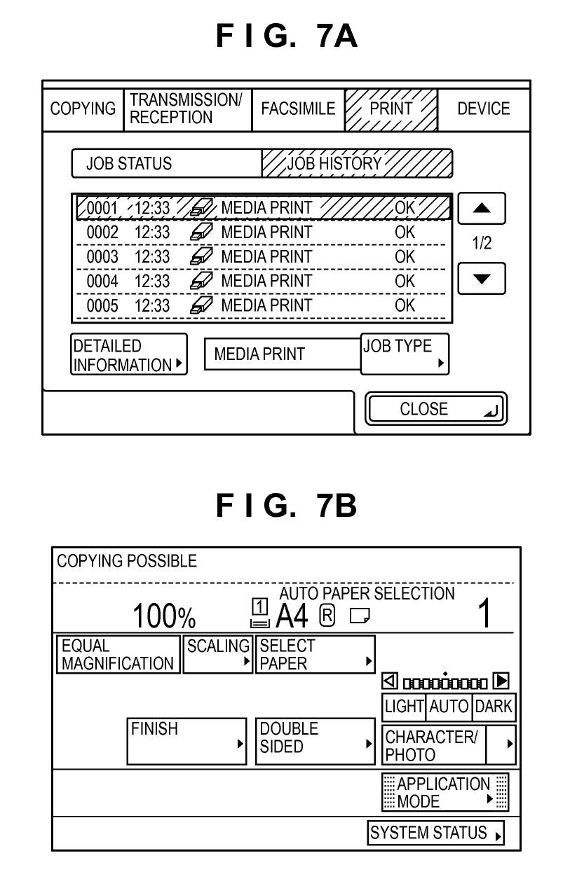

FIG. 3A depicts a view illustrating an example of a copy stand-by screen displayed on the operation panel 3000 when the operation panel 3000 is removed from the main body 1000 and it does not communicates with the main body 1000. Note that the screen displays a message indicating that the copying setting is possible. FIG. 3B depicts a view illustrating an example of a counter check screen indicating the number of paper sheets subjected to printing by the main body 1000. FIG. 4A depicts a view illustrating an example of an error screen indicating that a front cover or a left cover of the main body 1000 is opened. FIG. 4B depicts a view illustrating an example of an error screen indicating the occurrence of a jam during printing. FIG. 5A depicts a view illustrating an example of a device information screen indicating device information on the main body 1000 (paper cassette information, available functions etc.). In FIG. 5A, the sizes and amounts of paper sheets contained in the respective paper cassettes, and as available functions, scanner, printer, facsimile, network transmission/reception functions, and the like, are displayed. FIG. 5B depicts a view illustrating an example of a job status screen indicating a job status during job execution by the main body 1000. In FIG. 5B, it is understood that a copy job “0006” is performed and jobs “0007” and “0008” are in waiting. FIG. 6A depicts a view illustrating an example of a job status screen indicating a job status when the main body 1000 does not perform a job. FIG. 6B depicts a view illustrating an example of a job detail information screen information indicating the detailed information of a job with a reception No. “0010” performed by the main body 1000. FIG. 7A depicts a view illustrating an example of a job history screen indicating the history of jobs performed by the main body 1000. In FIG. 7A, “media print” indicates printing of image data stored in e.g. a USB memory, and “OK”, normal completion of the printing. FIG. 7B depicts a view illustrating an example of a copying stand-by screen when the operation panel 3000 communicates with the main body 1000. Note that the screen in FIG. 7B displays a message “copying is possible”.

Next, the initial screen display of the image forming apparatus according to the embodiment of the present invention will be described. In the image forming apparatus according to the present embodiment, the removable operation panel 3000 is set so as to display an information display screen to indicate a job status, a job history, counter information, error information, device information and the like, as an initial screen. When the removed operation panel 3000 is moved closer to the main body 1000 and communicable with the main body 1000, the initial screen is displayed in correspondence with the above setting.

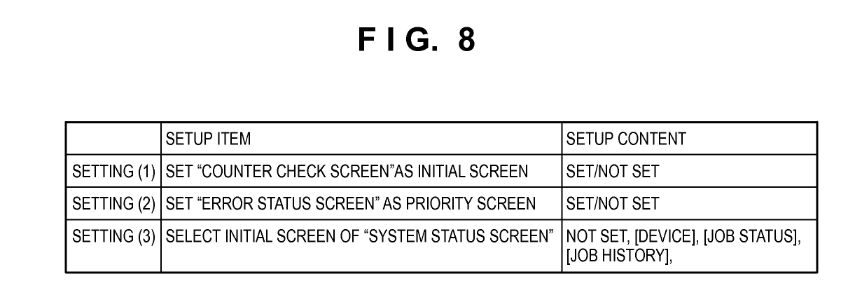

FIG. 8 shows an example of the initial screen settings in the operation panel 3000 according to the present embodiment. The initial screen settings in the present embodiment include the following settings (1) to (3) shown in FIG. 8.

(1) Setting Item (1) “set ‘counter check screen’ as initial screen” is to set whether or not the counter check screen in FIG. 3B is set as an initial screen.

(2) Setting Item (2) “set ‘error status screen’ as priority screen” is to set whether or not the error screen in FIG. 4A or 4B is displayed as a priority screen.

(3) Setting Item (3) “select initial screen of ‘system status screen’ is to set whether or not the device information screen in FIG. 5A, the job status screen in FIG. 5B or FIG. 6A, or the job history screen in FIG. 7A is set as an initial screen.

These initial screen settings can be set by the user by operating the operation panel 3000. These initial screen settings set with the operation panel 3000 are stored in the flash ROM 3107 of the operation panel 3000.

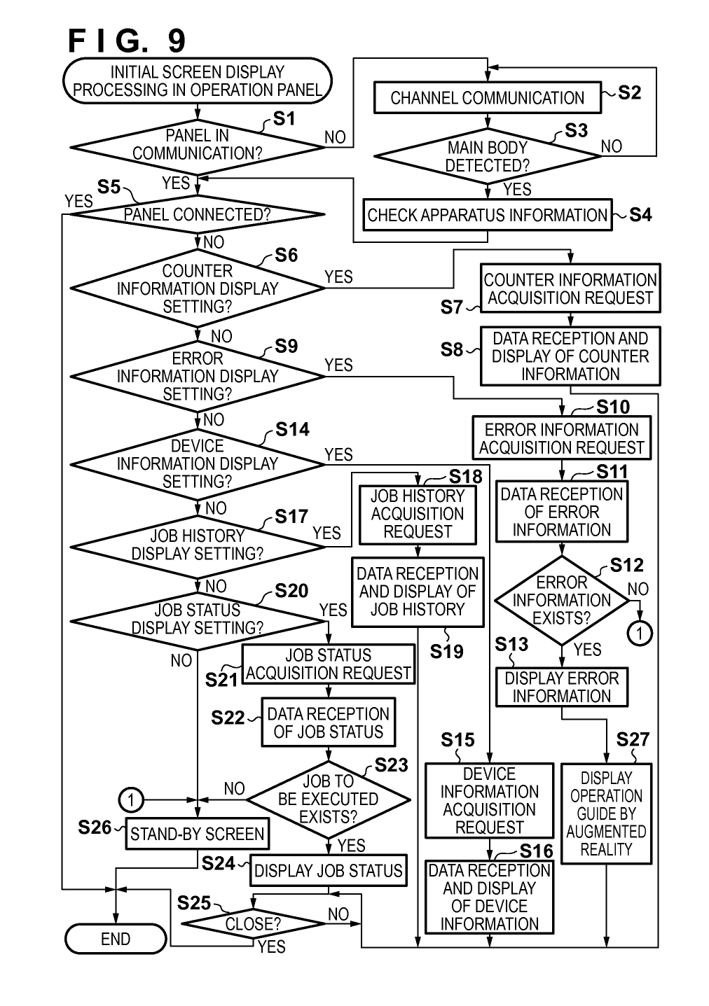

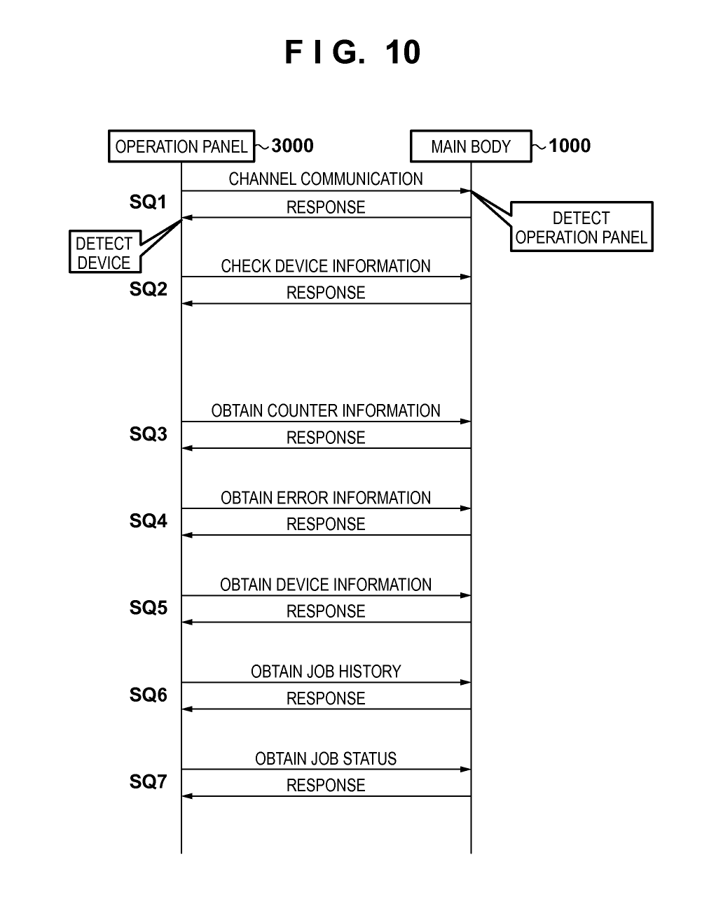

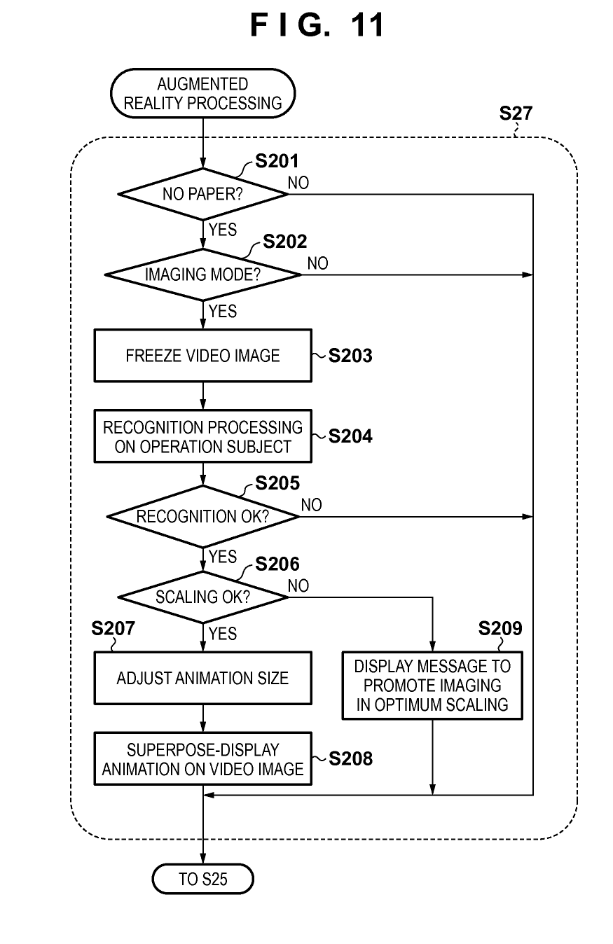

Hereinbelow, initial screen display processing in the image forming apparatus according to the present embodiment will be described with reference to FIG. 9, FIG. 10 and FIG. 11. Note that as described above, the main body 1000 and the operation panel 3000 establish IEEE 802.11b wireless communication by a known technique as a main channel. In FIG. 9, the establishment of wireless communication as a known technique will be omitted.

FIG. 9 is a flowchart for describing initial screen display processing by the operation panel 3000. FIG. 10 is a sequence diagram showing information transmission/reception between the operation panel 3000 and and the main body 1000.

First, the initial screen display processing by the operation panel 3000 will be described with reference to FIG. 9 and FIG. 10. Note that the respective steps in FIG. 9 are realized by reading the control program stored in the flash ROM 3107 and executing the program by the CPU 3101 of the operation panel 3000.

First, in step S1, the CPU 3101 of the operation panel 3000 determines the wireless communication status of the main channel (communication status determination processing), to determine whether or not wireless communication is being performed with the main body 1000. When it is determined that the wireless communication as a main channel is not performed, the process proceeds to step S2, in which the CPU 3101 transmits a request for establishment of main channel communication with the main body 1000 (SQ1 in FIG. 10) to the main body 1000. Note that when there are plural main bodies within a range of the radio wave of the main channel, ESSIDs for plural communicable main bodies are displayed on the operation panel 3000, then the user selects one of the ESSIDs, and the above-described request is transmitted to the main body of the selected ESSID. Then in step S3, the CPU 3101 determines whether or not the main body 1000 has been detected based on whether or not a response of allowance of communication has been received from the main body 1000. The processing in steps S2 and S3 is repeated until the main body 1000 has been detected. Then in step S3, when the main body 1000 has been detected, the CPU 3101 establishes main channel communication with the main body 1000, and the process proceeds to step S4. In step S4, the CPU 3101 checks the device information such as a device ID and available function information of the main body 1000 (SQ2 in FIG. 10). More particularly, the CPU 3101 transmits a device information check request (a request for checking device information such as the apparatus ID and available function of the main body 1000) to the main body 1000, and receives device information from the main body 1000. Then the process proceeds to step S5. On the other hand, when it is determined in step S1 that communication is being performed with the main body 1000 by the wireless communication as a main channel, the process proceeds to step S5.

In step S5, the CPU 3101 determines whether or not the operation panel 3000 is placed in the home position 2000 on the main body 1000 and the operation panel 3000 and the main body 1000 are connected. Then, when it is determined that the operation panel 3000 and the main body 1000 are connected, the CPU 3101 terminates the processing of the present flowchart. On the other hand, when it is determined that the operation panel 3000 and the main body 1000 are not connected, the process proceeds to step S6. Note that in step S6 and the subsequent steps, the CPU 3101 reads the initial screen settings (the settings (1) to (3) in FIG. 8) held in the flash ROM 3107, and performs the respective determinations.

In step S6, the CPU 3101 determines whether or not the setting (1) in FIG. 8 is setting to set the “counter check screen” as an initial screen. When it is determined that the setting (1) is setting to set the “counter check screen” as an initial screen, the process proceeds to step S7. In step S7, the CPU 3101 issues a counter information acquisition request to the main body 1000 (SQ3 in FIG. 10). Then in step S8, the CPU 3101 receives counter information data from the main body 1000, and displays a counter check screen (e.g. the screen in FIG. 3B) showing the received counter information. Then the process proceeds to step S25, in which the CPU 3101 stands by until the counter check screen (e.g. the screen in FIG. 3B) is closed. When the screen is closed, the process of the present flowchart ends.

On the other hand, in step S6, when it is determined that the setting (1) is not setting to set the “counter check screen” as an initial screen, the process proceeds to step S9. In step S9, the CPU 3101 determines whether or not the setting (2) in FIG. 8 is setting to set the “error status screen” as an initial screen. When it is determined that the setting (2) in FIG. 8 is setting the “error status screen” as a priority screen, the process proceeds to step S10. In step S10, the CPU 3101 issues an error information acquisition request to the main body 1000 (SQ4 in FIG. 10). Then in step S11, the CPU 3101 receives error information data from the main body 1000. Then in step S12, the CPU 3101 determines whether or not the data obtained from the main body 1000 in step S11 includes error information (i.e., an error occurs in the main body 1000). Then, when it is determined that the data obtained from the main body 1000 does not include error information (an error does not occur in the main body 1000), the process proceeds to stand-by processing in step S26. In step S26, the CPU 3101 displays a copy stand-by screen (e.g. a screen in FIG. 7B). Then the process of the present flowchart ends. Note that it may be arranged such that when it is determined in step S12 that error information is not included, the process may proceed to step S14. On the other hand, when it is determined in step S12 that error information is included in the data obtained from the main body 1000 (an error occurs in the main body 1000), the process proceeds to step S13. In step S13, the CPU 3101 displays an error screen displaying the error information. For example, when the front cover or the left cover of the main body 1000 is opened, an error screen indicating the position of the opened cover (e.g., the screen in FIG. 4A) is displayed. Further, when a jam occurs during printing in the main body 1000, an error screen indicating the position of the occurrence of the jam (e.g., the screen in FIG. 4B) is displayed. Then the process proceeds to step S27, in which a recording sheet supply procedure to the paper cassette is expressed by using an augmented reality technique, which is a characteristic feature of the present embodiment to be described later. Then in step S25, the CPU 3101 stands by until the above-described error screen is closed. When the screen is closed, the process of the present flowchart ends.

On the other hand, when it is determined in step S9 that the setting (2) in FIG. 8 is not setting to set the “error status screen” as a priority screen, the process proceeds to step S14. In step S14, the CPU 3101 determines whether or not the setting (3) in FIG. 8 is setting to select “device information screen” as an initial screen of a “system status screen”. When it is determined that the setting (3) is setting to select the “device information screen” as an initial screen of the “system status screen”, the process proceeds to step S15. In step S15, a device information acquisition request is issued to the main body 1000 (SQ5 in FIG. 10). Then in step S16, the CPU 3101 receives device information from the main body 1000, and displays a device information screen (e.g., the screen in FIG. 5A) displaying the received device information. Then the process proceeds to step S25, in which the CPU 3101 stands by until the above-described device information screen is closed. When the screen is closed, the process of the present flowchart ends.

On the other hand, when it is determined in step S14 that the setting (3) is not setting to select the “device information screen” as an initial screen of the “system status screen”, the process proceeds to step S17. In step S17, the CPU 3101 determines whether or not the setting (3) is setting to select the “job history screen” as an initial screen of the “system status screen”. When it is determined that the setting (3) is setting to select the “job history screen” as an initial screen of the “system status screen”, the process proceeds to step S18. In step S18, the CPU 3101 issues a job history acquisition request to the main body 1000 (SQ6 in FIG. 10). Then the process proceeds to step S19, in which the CPU 3101 receives job history data from the main body 1000, and displays a job history screen (e.g., the screen in FIG. 7A) displaying the received data. Then the process proceeds to step S25, in which the CPU 3101 stands by until the above-described job history screen is closed. When the screen is closed, the process of the present flowchart ends.

On the other hand, when it is determined in step S17 that the setting (3) is not setting to select the “job history screen” as an initial screen of the “system status screen”, the process proceeds to step S20. In step S20, the CPU 3101 determines whether or not the setting (3) is setting to select the “job status screen” as an initial screen of the “system status screen”. When it is determined that the setting (3) is setting to select the “job status screen” as an initial screen of the “system status screen”, the process proceeds to step S21. In step S21, a job status acquisition request is issued to the main body 1000 (SQ7 in FIG. 10). Next, the process proceeds to step S22, at which the CPU 3101 receives data indicating the job status from the main body 1000. Then in step S23, the CPU 3101 determines based on the received data whether or not a currently-performed job exists. When it is determined that a currently-performed job exists, the process proceeds to step S24. In step S24, the CPU 3101 displays a job status screen (e.g., the screen in FIG. 5B) displaying the received job history data. Then in step S25, the CPU 3101 stands by until the above-described job status screen is closed. When the screen is closed, the process of the present flowchart ends.

On the other hand, when it is determined in step S23 that any currently-performed job does not exist, the process proceeds to step S26. In step S26, the CPU 3101 displays a copy stand-by screen (e.g., the screen in FIG. 7B), and the process of the present flowchart ends.

Next, the details of the processing in step S27 in FIG. 9 as a characteristic feature of the embodiment of the present invention will be described with reference to the flowchart of FIG. 11. The processing in step S27 is performed with e.g. an operation guide to replenish paper to an upper cassette by using the augmented reality technique.

FIG. 11 is a flowchart for describing augmented reality processing (S27) by the operation panel 3000. Note that the respective steps in the flowchart of FIG. 11 are realized by reading the control program stored in the flash ROM 3107 and executing the program by the CPU 3101 of the operation panel 3000.

First, in step S201, when the error information from the main body 1000 indicates depletion of paper, the process proceeds to step S202, in which it is determined whether or not the current mode is changed to an imaging mode by depression of an imaging mode key (not shown) displayed on the display unit 3200 by the operator. The imaging mode is a mode to display a video image obtained with the image module 3110 on the display unit 3200. Accordingly, when the operator performs imaging with the image module 3110 directed toward the front surface of the main body 1000 while watching the display unit 3200, video image information including a cassette to which recording paper is to be replenished is obtained. Accordingly, when it is determined that the current mode is the imaging mode, the process proceeds to step S203, in which frame image data from the frame buffer 3109 is temporarily stored in the RAM 3108.

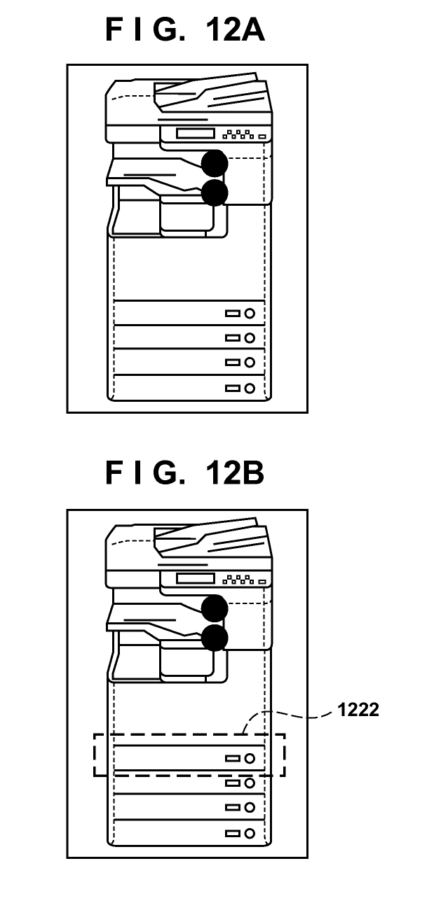

FIGS. 12A and 12B to FIGS. 14A and 14B are explanatory diagrams of a display example as a characteristic feature of the present embodiment.

The video image information stored as above is, e.g., as shown in FIG. 12A. Next, in step S204, the CPU 3101 performs recognition processing on the upper cassette to which the operator is to replenish paper, from the video image information. The recognition processing is performed on previously registered cassettes by using known pattern matching or the like from the video image shown in FIG. 12A. FIG. 12B shows the recognized upper cassette surrounded by a broken line 1222. Note that when the video image does not include the upper cassette as a result of the series of recognition processes, since the upper cassette cannot be recognized, it is determined in step S205 that recognition failed, and the process branches to step S25. When the upper cassette has been recognized, the process proceeds to step S206, in which the scaling of the video image itself is evaluated. That is, it is determined whether or not the recognition subject is displayed in a predetermined size. When it is determined that the subject is not displayed in the predetermined size, the process proceeds to step S209. In step S209, for example, when the display size of the subject is too large, a message, e.g., “Please shoot in a position a little away from the subject.”, or when the display size of the subject is too small, a message, e.g., “Please shoot in a position closer to the subject”, is superimposed on the obtained video image.

When it is determined in step S206 that the subject is displayed in the predetermined size, the process proceeds to step S207, in which the size of prepared operation guide animation is adjusted. This adjustment is performed for the purpose of changing the size of the cassette in the animation to a size approximately corresponding to the size of the cassette recognized in FIG. 12B. The adjustment is necessary processing to superpose the both images by watermark combining and display the combined image in step S208.

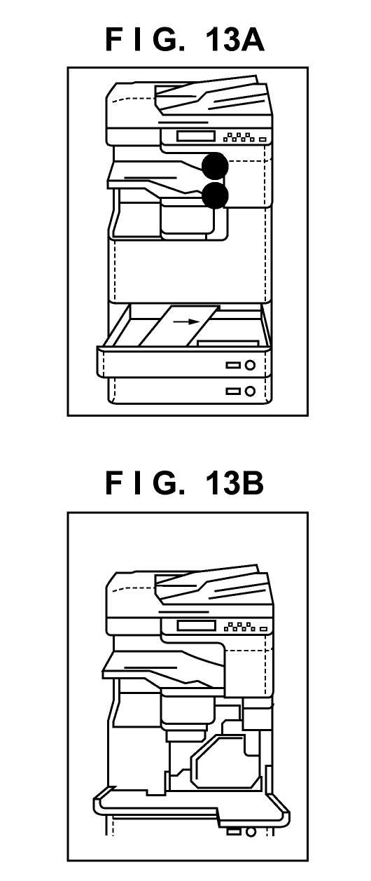

FIG. 13A shows an example of a final display screen on the display unit 3200 where the actual video image and the animation are superimposed. Note that the animation in FIG. 13A expresses the process of pulling the upper cassette frontward and replenishing paper in a predetermined size.

The above operation guide display in step S27 using the augmented reality technique is basically maintained until the error status is released.

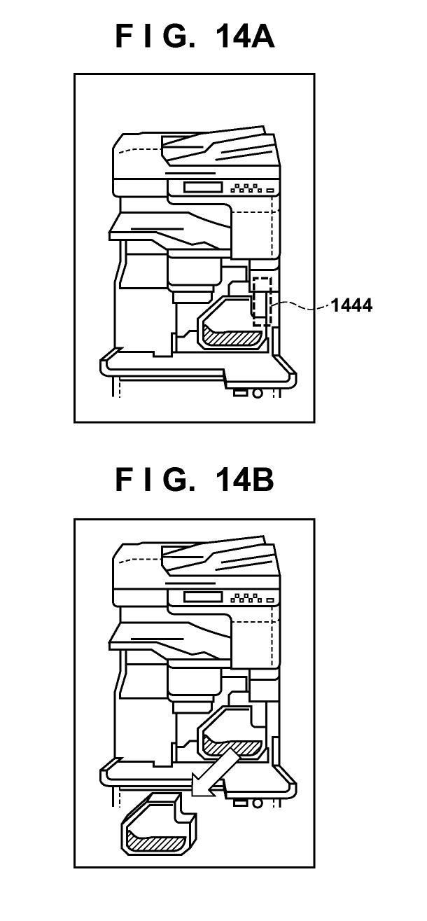

Next, an example of the error upon overflow of waste toner container will be described with reference to FIG. 13B to FIGS. 14A and 14B.

The flow of this processing is realized similarly to the aforementioned processing described with reference to the flowchart of FIG. 11, therefore, it will be omitted here. The processing is the same as the previous processing except step S201 in FIG. 11 in which it is determined whether or not the waste toner container is in overflow status. That is, the operator opens the front cover of the apparatus and performs imaging on the entire front surface, then a video image shown in FIG. 13B is obtained.

In the recognition processing in step S204, first, a release lever of the waster toner container is recognized. When the release lever is recognized, it is displayed with a broken line 1444 as shown in FIG. 14A. In this case, the waste toner container to be exchanged is similarly recognized, and the operator is informed of the recognition and the position of the waste toner container with e.g. a yellow pattern. FIG. 14B shows a status where the waste toner container is removed.

Note that in this case, the animation expresses processes of turning the release lever of the waste toner container at a predetermined angle to release the lock of the waste toner container, and taking the waste toner container to a front position. In this manner, the animation where the release lever and the waste toner container in approximately the same size are superimposed in the actual video image and the images are watermark-combined. Accordingly, a display expressing as if actual members move can be produced.

Note that although already explained in FIG. 11, the operation guide display using the augmented reality technique according to the present embodiment is displayed as a combined image where animation generated by CG or the like is superimposed on a video image obtained with the image module 3110 provided in the rear of the display unit 3200 of the operation panel 3000. Accordingly, when the operation panel 3000 is in the home position 2000 of the main body 1000, the operation subject is not image-captured with the imaging module 3110 and the operation guide display is not performed in this status.

The augmented reality technique according to the present embodiment can be adopted upon various error recovery and adjustment in the image forming apparatus. Accordingly, all the error recovery and adjustment operations detected by the main body 1000, the animation CG as operation guide and the recognition subject are associated with each other, and respectively used selectively in accordance with determination similar to that in step S201 in FIG. 11. Note that in a large machine, a paper jam may occur in plural positions. In such case, plural brief paper jam positions are recognized and displayed in an actual video image of the entire apparatus. Then, a paper removal guide procedure can be easily realized at the respective paper jam positions.

Next, data processing in the main body 1000 will be described with reference to FIGS. 15, 16 and 10.

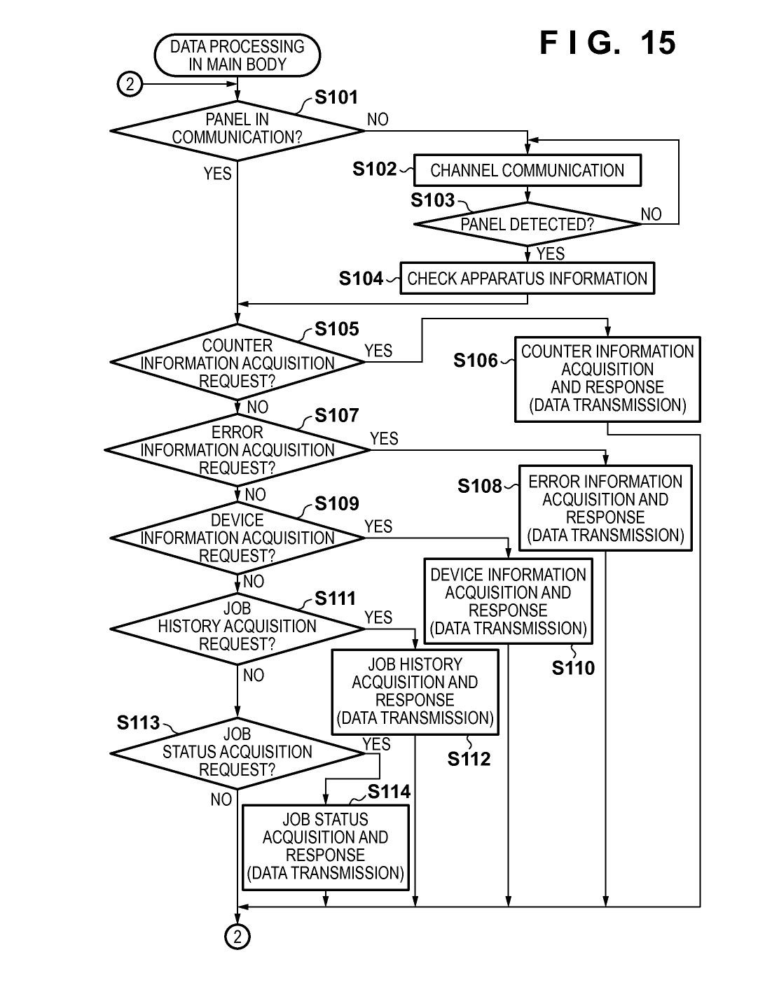

FIG. 15 is a flowchart for describing the processing in the main body 1000 according to the present embodiment. Note that the respective steps in the flowchart of FIG. 15 are realized by reading the control program stored in the flash ROM 1102 and executing the program by the CPU 1101 of the main body 1000.

First, in step S101, the CPU 1101 of the main body 1000 determines the wireless communication status of the main channel (communication status determination processing), and determines whether or not wireless communication is being performed with the operation panel 3000. Then, when it is determined that wireless communication as a main channel is not performed, the process proceeds to step S102. In step S102, the CPU 1101 broadcasts information including the ESSID as processing for main channel communication, to notify the operation panel 3000 of its own ESSID, then the process proceeds to step S103. In step S103, the CPU 1101 determines whether or not the operation panel 3000 has been detected based on whether or not the above request (SQ1 in FIG. 10) from the operation panel 3000 has been received. The processing in step S102 is repeated until the operation panel 3000 is detected. When it is determined in step S103 that the operation panel 3000 has been detected, the CPU 1101 transmits a response indicating allowance of communication to the operation panel 3000, to establish main channel communication with the operation panel 3000. Then the process proceeds to step S104. In step S104, the CPU 1101 performs device information check processing (SQ2 in FIG. 10). More particularly, the CPU 1101 receives the device information check request (the request for checking of the apparatus information such as the device ID and available function of the main body 1000) transmitted from the operation panel 3000, then obtains the device information held in the flash ROM 1102 and transmits the information to the operation panel 3000. Then the process proceeds to step S105. Note that in step S101, when it is determined that communication is performed with the operation panel 3000 by the wireless communication as a main channel, the process proceeds to step S105.

In step S105, the CPU 1101 determines the presence/absence of the counter information acquisition request (SQ3 in FIG. 10) transmitted from the operation panel 3000. When it is determined that the counter information acquisition request has been received, the CPU 1101 proceeds to step S106. In step S106, the CPU 1101 obtains the count information held in the nonvolatile memory (e.g. the flash ROM 1102 or the HDD 1400) of the main body 1000, and transmits the information to the operation panel 3000. Then the process returns to step S101.

On the other hand, when it is determined in step S105 that the counter information acquisition request has not been received, the process proceeds to step S107. In step S107, the CPU 1101 determines the presence/absence of the error information acquisition request (SQ4 in FIG. 10) transmitted from the operation panel 3000. When it is determined that the error information acquisition request has been received, the process proceeds to step S108. In step S108, the CPU 101 obtains the error information on an error which occurs in the main body 1000 from the nonvolatile memory (e.g., the flash ROM 1102 or the HDD 1400) of the main body 1000, and transmits the information to the operation panel 3000. Then the process returns to step S101.

On the other hand, when it is determined in step S107 that the error information acquisition request has not been received, the process proceeds to step S109. In step S109, the CPU 1101 determines the presence/absence of the device information acquisition request (SQ5 in FIG. 10) transmitted from the operation panel 3000. When it is determined that the device information acquisition request has been received, the process proceeds to step S110. In step S110, the CPU 1101 obtains the device information on the main body 1000 from the nonvolatile memory (e.g., the flash ROM 1102 or the HDD 1400) of the main body 1000, and transmits the information to the operation panel 3000. Then the process returns to step S101. On the other hand, when it is determined in step S109 that the device information acquisition request has not been received, the process proceeds to step S111.

In step S111, the CPU 1101 determines the presence/absence of the job history acquisition request (SQ6 in FIG. 10) transmitted from the operation panel 3000. When it is determined that the job history acquisition request has been received, the process proceeds to step S112. In step S112, the CPU 101 obtains the job history in the main body 1000 from the nonvolatile memory (e.g., the flash ROM 1102 or the HDD 1400) of the main body 1000, and transmits the information to the operation panel 3000. Then the process returns to step S101. On the other hand, when it is determined that the job history acquisition request has not been received in step S111, the process proceeds to step S113. In step S113, the CPU 1101 determines the presence/absence of the job status acquisition request (SQ7 in FIG. 10) transmitted from the operation panel 3000. When it is determined that the job status acquisition request has been received, the process proceeds to step S114. In step S114, the CPU 1101 obtains the job status of the main body 1000 from the nonvolatile memory (e.g., the flash ROM 1102 or the HDD 1400) of the main body 1000, and transmits the information to the operation panel 3000. Then the process returns to step S101. On the other hand, when it is determined that the job status acquisition request has not been received in step S113, the CPU 1101 returns to step S101 without any processing.

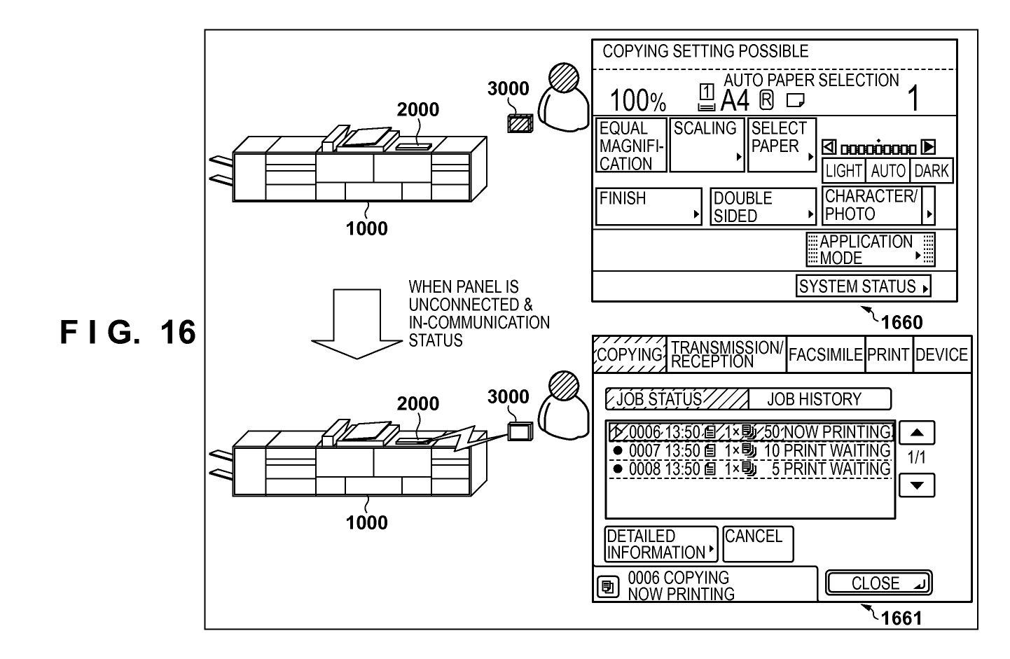

Next, a particular example of the operation using the operation panel 3000 according to the embodiment will be described using FIG. 16.

FIG. 16 depicts a view illustrating a particular example of the operation using the operation panel 3000 according to the embodiment.

In this example, the operation panel 3000 is previously set to select the “job status screen” as an initial screen of the “system status screen” (FIG. 8) in the setting (3). Note that in the setting (1), “not set”, and no error occurs in the main body 1000.

In FIG. 16, reference numeral 1660 denotes a screen displayed on the operation panel 3000 removed from the main body 1000 and in non-communication status. In the present embodiment, in the non-communication status, the screen in FIG. 3A is displayed. Numeral 1661 denotes an example of a screen displayed on the operation panel 3000 when the operation panel 3000 removed from the main body 1000 is moved closer to the main body 1000 and becomes in the main channel communication status with the main body 1000. In this example, in correspondence with initial screen setting, a screen indicating the job status performed by the main body 1000 (job status screen) is displayed on the operation panel 3000.

Note that in the above embodiment, the animation information is stored in the flash ROM 3107 of the operation panel 3000, however, the present invention is not limited to this arrangement. For example, control may be performed such that the animation information is stored in the HDD 1400 of the main body 1000, then in step S207 of FIG. 11, the animation information is transmitted from the main body 1000 to the operation panel 3000, then the animation video image is combined and displayed. In this case, the CPU 1101 of the main body 1000 functions as a display controller to display animation (CG).

Further, the recognition unit to recognize a part as the operation subject from a video image captured and displayed on the display unit may be included not only in the operation panel 3000 but also in the main body 1000. In such case, it is necessary to transmit video image information obtained with the operation panel 3000 to the main body 1000 by main channel communication.

As described above, according to the present embodiment, when the operator has to perform maintenance or adjustment work, the operator uses the operation panel 3000, which is capable of wireless communication with the main body 1000 and which has a camera function, to display a video image of a peripheral area of a particular work position in the image forming apparatus. Then, the operation subject is automatically recognized from the video image. Then previously-stored operation guide animation CG is watermark-combined with the recognized operation subject and the combined image is displayed for explaining a necessary operation. With this arrangement, it is possible to guide the operator to perform a proper and quick operation.

Further, as the video image capture is performed with the camera provided in the rear of the operation panel 3000, the operator can work while observing the operation subject and the display on the operation panel 3000 simultaneously.

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2010-245705, filed Nov. 1, 2010, which is hereby incorporated by reference herein in its entirety.

1. An image forming apparatus for forming an image on a recording medium based on image data, comprising:
mounting means for removably mounting an operation panel having a display unit, an imaging unit, and a wireless communication unit communicable with the image forming apparatus;
communication means for wireless communication with the wireless communication unit of the operation panel; and
control means for, in a status where the operation panel is not mounted on said mounting means, performing control to combine an image indicating an operation method with a video image obtained by the imaging unit and displayed on the display unit and display the combined image.

2. The image forming apparatus according to claim 1, wherein the imaging unit performs imaging on a front perpendicular to a screen of the display unit.

3. The image forming apparatus according to claim 1, wherein the combined image is a CG image for operation guidance.

4. The image forming apparatus according to claim 1, further comprising:
recognition means for recognizing a part as an operation subject from the video image obtained by the imaging unit and displayed on the display unit,
wherein said control means performs control to combine the part recognized by said recognition means with an image corresponding to a current error and display the combined image.

5. A control method for an image forming apparatus having a mounting unit to removably mount an operation panel having a display unit, an imaging unit, and a wireless communication unit communicable with an image forming apparatus, comprising:
a communication step of performing wireless communication with the wireless communication unit of the operation panel; and
a control step of, in a status where the operation panel is not mounted on the mounting unit, performing control to combine an image indicating an operation method with a video image obtained by the imaging unit and displayed on the display unit and display the combined image.

6. An image display apparatus having a display unit and an imaging unit, removable from an image forming apparatus, comprising:
wireless communication means for wireless communication with the image forming apparatus;
display control means for, in a status where the operation panel is not mounted on the image forming apparatus, displaying a video image obtained by the imaging unit on the display unit;
acquisition means for acquiring information on an error occurred in the image forming apparatus;
recognition means for recognizing a part as an operation subject from the video image displayed by said display control means based on the information related to the error acquired by said acquisition means; and
operation guide display means for combining an image indicating an operation guide corresponding to the part recognized by said recognition means, based on the information related to the error, with the video image, and displaying the combined image.

7. The image display apparatus according to claim 6, wherein the display unit and the imaging unit are integrally formed, and wherein the imaging unit performs imaging on a front perpendicular to a screen of the display unit.
